(19) United States
(12) Patent Application Publication
(10) Pub. No.: US 2024/0081326 A1
(43) Pub. Date: Mar. 14, 2024

(54) Use of a Biobased Composition Comprising Ferulated Chitosan as a Pesticide Safener

(71) Applicant: FYTEKO SA, Bruxelles (BE)

(72) Inventors: Guillaume WÉGRIA, Bruxelles (BE); Juan-Carlos CABRERA PINO, Bruxelles (BE)

(21) Appl. No.: 18/267,983

(22) PCT Filed: Dec. 22, 2021
(86) PCT No.: PCT/EP21/87254

§ 371 Date: Jun. 16, 2023

(30) Foreign Application Priority Data
Dec. 22, 2020 (BE) 2020/5965

(51) Int. Cl. A01N 25/32; A01N 25/30; A01N 43/16; A01N 43/18; A01N 43/50; A01N 43/58; A01P 3/00; A01P 13/00

(52) U.S. Cl. CPC A01N 25/32; A01N 25/30; A01N 43/16; A01N 43/18; A01N 43/50; A01N 43/58; A01P 3/00; A01P 13/00

(57) ABSTRACT

The current invention relates to use of a composition for reducing the phytotoxicity of a herbicide and/or fungicide towards a targeted plant, said composition comprising a ferulated chitosan, wherein said composition is applied to said targeted plant, to soil in contact with said targeted plant and/or to plant seeds of said targeted plant.

### FIELD OF THE INVENTION

The present invention relates to a composition comprising ferulated chitosan. In particular, the present invention concerns a composition comprising ferulated chitosan for reducing the phytotoxicity of a herbicide and/or fungicide towards a targeted plant.

### BACKGROUND

Over the years the world population has steadily increased, while the amount of land available for agricultural activities is becoming more and more scarce. The agricultural industry is therefore facing the particular challenge of producing larger amounts of crops on yet less available land.

In order to efficiently grow agricultural crops, an important problem to be addressed is efficiently combating weeds a crop, i.e. unwanted plants which are competing with the crop of interest, or other competing organisms, such as pathogens. Compounds specifically designed and used to control unwanted plants such as agricultural weeds are known as herbicides. In extensive agriculture practice, their use is currently compulsory in order to sustain food security. However, herbicides must fulfil two contradictory objectives: on one hand controlling agricultural weed, on the other hand not injuring the crops of choice. This is often a difficult balance, as certain crops can be taxonomically quite close to weeds. Herbicides must therefore be as selective as possible in their herbicidal action. However despite this selectivity, herbicides often have phytotoxic effects on the crop of interest as well. In particular, this phytotoxicity can result in temporary or long-lasting damage to plants. Often the symptoms of phytotoxicity will be inconspicuous, i.e. inhibition or delay in emergence or growth, phenological modifications, delays in flowering, fruiting and ripening. In other cases, their negative effect is more visible, i.e. modification of color, necrosis, deformations, and ultimately a lower crop yield.

Similarly, some fungicides designed and used to control pathogen on crops, have some adverse effect on germination, seedling establishment and plant growth when used in seed application. Symptoms due to these fungicides will mostly be inconspicuous, i.e. inhibition or delay in emergence or growth, reductions in lengths of the coleoptile, the first leaf and the sub-crown internode, change in tiller appearance, modifications of root-system development; but ultimately also result in a lower yield.

Compositions to reduce certain phytotoxic effects of herbicides and/or fungicides are known, e.g. from US 2010 0 137 138. Such compounds are however further chemical compounds. As public opinion on chemical products is especially sensitive in the area of agriculture, using additional chemical compounds such the compounds of US '138 is not desired. In particular, the use of chemical compounds for agricultural purposes is often associated with a certain risk of toxicity, or a substantial ecological burden on the environment. Furthermore, chemical safener compounds are known to increase weed resistance, thus making herbicides less effective.

Hence, there remains a need in the art for novel compositions with allow to reduce phytotoxic effects of herbicides and/or fungicides in crops of interest, which are non-chemical, bio-based, safe and/or non-toxic, and which have a high bio-availability to plants, hereby allowing both the inhibition of phytotoxic effects of herbicides and/or fungicides, and the successful support of plant growth and/or yield.

### SUMMARY OF THE INVENTION

The present invention and embodiments thereof serve to provide a solution to one or more of above-mentioned disadvantages. To this end, the present invention relates to use of a composition comprising a ferulated chitosan for reducing the phytotoxicity of a herbicide and/or fungicide towards a targeted plant according to claim 1.

It was surprisingly found that ferulated chitosan can be successfully used to reduce the phytotoxic effects of herbicides and/or fungicides. The composition as described herein is particularly advantageous because the composition is bio-based, safe to use, has high bio-availability, and furthermore aids in efficiently combating of weeds in crops of plants without negatively impacting the plant growth and/or harvest yield.

Preferred embodiments of the present use are disclosed in claims 2 to 16.

### DESCRIPTION OF FIGURES

FIG. 1 shows UV spectra comparing unmodified chitosan and the ferulated chitosan following an embodiment of the present invention.

FIG. 2 shows FTIR spectra comparing unmodified chitosan and the ferulated chitosan following an embodiment of the present invention.

FIG. 3 shows the relative growth rate of Lamina minor plants treated with a herbicide and with a composition comprising ferulated chitosan according to an embodiment of the present invention.

FIG. 4 shows the relative growth rate of Lamina minor plants treated with a herbicide and with a composition comprising chitosan.

FIG. 5 shows the relative growth rate of Lamina minor plants treated with a herbicide and with a composition comprising ferulic acid.

FIG. 6 shows the survival rate of Lemna minor plants treated with a herbicide alone (light grey) or with a combination of a herbicide and a ferulated chitosan according to an embodiment of the present invention.

FIG. 7 shows the final yield of soybean crops treated with a fungicide alone or in combination with a ferulated chitosan according to an embodiment of the present invention.

FIG. 8 shows the modified Anthocyanin reflectance index in Lemna minor plants treated with Triflusulfuron-methyl and a ferulated chitosan according to an embodiment of the present invention.

FIG. 9 shows the modified Anthocyanin reflectance index in Lemna minor plants treated with Profoxydim and a ferulated chitosan according to an embodiment of the present invention.

FIG. 10 shows the modified Anthocyanin reflectance index in Lemna minor plants treated with Phenmediphan and a ferulated chitosan according to an embodiment of the present invention.

FIG. 11 shows the modified Anthocyanin reflectance index in Lemna minor plants treated with Ethofumesate and a ferulated chitosan according to an embodiment of the present invention.

FIG. 12 shows the effect of seed treatment with a ferulated chitosan according to an embodiment of the present invention on phytotoxicity caused by fungicides.

FIG. 13 shows the characterization by size exclusion chromatography of ferulated chitosan according to an embodiment of the present invention.

### DETAILED DESCRIPTION OF THE INVENTION

The present invention concerns the use of a composition comprising a ferulated chitosan for reducing the phytotoxicity of a herbicide and/or fungicide towards a targeted plant.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “% wt.” or “wt. %”, here and throughout the description unless otherwise defined, refers to the relative weight of the respective component based on the overall weight of the formulation.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

The present invention relates to use of a composition for reducing the phytotoxicity of a herbicide and/or fungicide towards a targeted plant, said composition comprising a ferulated chitosan, wherein said composition is applied to said targeted plant, to soil in contact with said targeted plant, and/or to plant seeds of said targeted plant. The inventors have surprisingly found that ferulated chitosan can be successfully used to reduce the phytotoxic effects of herbicides and/or fungicides. The composition as described herein is particularly advantageous because the composition is bio-based, safe to use, has high bio-availability, and furthermore aids in efficiently combating of pathogenic fungi and/or weeds in crops of plants without negatively impacting the plant growth and/or harvest yield.

The term “ferulated chitosan”, indicates a compound having a chitosan backbone, whereupon ferulic acid is grafted on the chitosan's amine group. In the context of the present invention, “chitosan” need to be interpreted as a linear polysaccharide composed of randomly distributed beta-(1-4) linked D-glucosamine and N-acetyl-D-glucosamine moieties. The term “ferulic acid”, also known as ((2E)-3-(4-hydroxy-3methoxyphenyl)prop-2-enoic acid, is thus grafted on the chitosan, preferably on chitosan's amine group, and can possibly be grafted as a monomer, dimer and/or trimer, and/or in different isomer forms.

It is a key advantage of the herein described us of the composition comprising ferulated chitosan, that use of the composition results in the efficient reduction of phytotoxicity effects due to the use of herbicides and/or fungicides in targeted plants.

As such, by using the composition as described herein, herbicides and/or fungicides can be used without negatively impacting the seed germination, plant growth and/or harvest yield of a targeted plant, meanwhile effectively combating unwanted weed. In contrast to known herbicide safeners, the composition is of a biological nature, is of no risk to the environment and poses no risk of inducing resistance towards herbicides in weed.

In some embodiments, said reducing the phytotoxicity of a herbicide and/or fungicide comprises lowering anthocyanin induction in the targeted plant. In some plants, anthocyanin accumulation is a typical symptom of phytotoxicity after the application of different herbicides, and it has been associated to plant growth reduction. Use of the present composition efficiently allows lowering said anthocyanin induction, thus supporting plant growth.

According to some embodiments, said reducing the phytotoxicity of a herbicide and/or fungicide comprises increasing harvest yield of said targeted plant.

According to some embodiments, said reducing the phytotoxicity of a herbicide and/or fungicide comprises increasing plant seed germination and enhancing plant seedlings growth. In particular, applying the composition of the invention to plant seeds of the targeted plant thus yields the advantageous effect of increased seed germination and seedling growth.

A further or another embodiment of the present invention relates to use of the composition wherein said ferulated chitosan has a concentration of between 0.01 to 100.000 ppm based on the total weight of said composition. Within said concentration range, the composition shows does not pose any risk of toxicity in the environment, meanwhile efficiently reducing the phytotoxic effects caused by herbicides and/or fungicides. By preference, the ferulated chitosan has a concentration of between 0.01 to 5.000 ppm, more by preference of between 0.01 to 4.000 ppm, of between 0.01 to 3.000 ppm, 0,011 to 2.000 ppm, 0.01 to 1.500 ppm, or of between 0.01 to 1.000 ppm based on the total weight of the composition. In some embodiments, the composition can be in a more concentrated form, which is preferred for transport and storing the composition, wherein the ferulated chitosan has a concentration of between 500 to 1.000 ppm, by preference of between 600 to 900 ppm, more by preference of between 700 to 800 ppm. In some embodiments, the composition is in a more diluted form, which is preferred for direct application to plants, wherein the ferulated chitosan has a concentration of between 0.01 to 50 ppm, by preference of between 0.05 to 25 ppm, more by preference of between 0.1 to 10 ppm.

In an embodiment, ferulated chitosan is produced according to a method comprising the steps of:
dispersing chitosan in a solution with a pH between 5.0 and 9.0 and adding ferulic acid and an enzyme of the family of multi-copper oxidases, obtaining a mixture;
allowing the mixture to enzymatically react;
recovering a precipitate from the reacted mixture.

In an embodiment, ferulated chitosan is produced according to a method comprising the steps of:
dispersing powdered chitosan in a solution with a pH between 5.0 and 9.0, preferably with a pH between 6.0 and 8.0, more preferably a phosphate buffer solution with a pH of 6.8-7.2;
adding ferulic acid to the solution with chitosan, preferably a solution of 2-10 mM of ferulic acid, more preferably a solution of 4.5-5.5 mM of ferulic acid in methanol;
adding an enzyme of the family of multi-copper oxidases (MCOs) to the solution with chitosan and ferulic acid, preferably the enzyme is laccase, more preferably a laccase solution of 0.5-2.0 U/mL is added;
allowing the solution to enzymatically react, preferably at a temperature of 15-40° C. and under agitation, during 1-24 hours, more preferably at 25-35° C. and under agitation at 100-140 rpm, during 3-5 hours;
recovering a precipitate, preferably by centrifugation;
washing the recovered precipitate with a buffer, preferably with a phosphate buffer;
washing with an alcohol the washed precipitate, preferably two washing steps with two different methanol solutions, more preferably the two methanol solutions have a concentration of 45-55% and 85-95%, respectively.

Without wanting to be bound by theory, the enzymatic reaction between chitosan and ferulic acid may lead to many different products. In some embodiments, ferulated chitosan comprises several different molecules comprising at least one ferulic acid moiety grafted on a D-glucosamine moiety of chitosan.

In order to remove laccase and to purify the ferulated chitosan, a washing step with a buffer is conducted. The washing with an alcohol removes the unreacted ferulic acid. This way a purer ferulated chitosan is obtained.

Said ferulated chitosan according to some embodiments comprises an oligomeric and/or polymeric compound following formula (I)

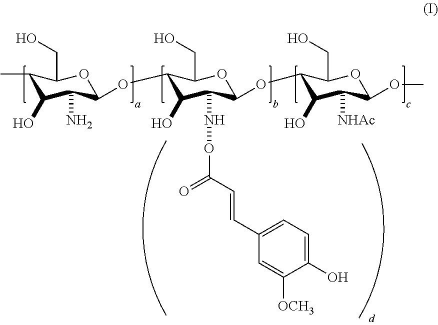

which compound comprises a D-glucosamine moiety (a), a ferulated D-glucosamine moiety (b), and an acetylated D-glucosamine moiety (c), wherein said moieties are randomly distributed in said compound following a ratio a:b:c, wherein:
a+b+c>15;
b/(a+b+c)<0.10; and
c/(a+b+c)<0.30;
   and wherein d=1, 2 or 3.

The ferulated chitosan described herein shows excellent bio-availability in plants, wherein it can optimally reduce the phytotoxic effects of herbicides and/or fungicides. More by preference, said moieties are randomly distributed following the ratio a:b:c, wherein:
a+b+c>20;
b/(a+b+c)<0.10; and
c/(a+b+c)<0.10;
   and wherein d=1, 2 or 3.

Even more by preference, a+b+c>100, a+b+c>250, a+b+c>500, most by preference 600<a+b+c<1000.

Without wanting to be bound by theory, ferulated chitosan can comprise said randomly distributed moieties in many different formations, not only as shown in formula I. In an embodiment, ferulated chitosan comprises ferulic acid covalently bound with chitosan via its benzene moiety. In an embodiment, ferulated chitosan comprises ferulic acid covalently bound with chitosan via its carboxyl moiety. In an embodiment, ferulated chitosan comprises ferulic acid covalently bound with chitosan via its hydroxyl moiety. In an embodiment, ferulated chitosan comprises chitosan covalently bound with ferulic acid via its hydroxyl group on the third carbon atom of a D-glucosamine moiety. In an embodiment, ferulated chitosan comprises chitosan covalently bound with ferulic acid via its hydroxyl group on the sixth carbon atom of a D-glucosamine moiety. In an embodiment, ferulated chitosan comprises ferulic acid covalently bound with chitosan via an imine bound. In an embodiment, ferulated chitosan comprises ferulic acid ionically bond to chitosan.

In an embodiment, ferulated chitosan comprises a D-glucosamine moiety (a), a ferulated D-glucosamine moiety (b), and an acetylated D-glucosamine moiety (c), wherein said moieties are randomly distributed in said compound following a ratio a:b:c, wherein:
a+b+c>15;
b/(a+b+c)<0.10; and
c/(a+b+c)<0.30;
   and wherein d=1, 2 or 3.

More by preference, said moieties are randomly distributed following the ratio a:b:c, wherein:
a+b+c>20;
b/(a+b+c)<0.10; and
c/(a+b+c)<0.10;
   and wherein d=1, 2 or 3.

Even more by preference, a+b+c>100, a+b+c>250, a+b+c>500, most by preference 600<a+b+c<1000.

Without wanting to be bound by theory, the bond between the chitosan and ferulic acid could be ionic according to Formula II:

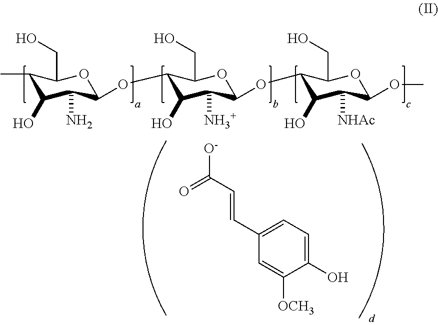

which compound comprises a D-glucosamine moiety (a), a ferulated D-glucosamine moiety (b), and an acetylated D-glucosamine moiety (c), wherein said moieties are randomly distributed in said compound following a ratio a:b:c, wherein:
a+b+c>15;
b/(a+b+c)<0.10; and
c/(a+b+c)<0.30;
and wherein d=1, 2 or 3.

Without wanting to be bound by theory, the bond between the chitosan and ferulic acid could be ionic according to Formula III:

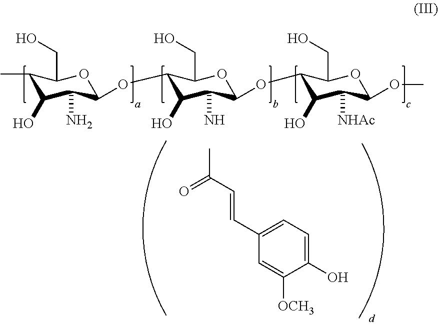

which compound comprises a D-glucosamine moiety (a), a ferulated D-glucosamine moiety (b), and an acetylated D-glucosamine moiety (c), wherein said moieties are randomly distributed in said compound following a ratio a:b:c, wherein:
a+b+c>15;
b/(a+b+c)<0.10; and
c/(a+b+c)<0.30;
   and wherein d=1, 2 or 3.

The ferulated chitosan described herein shows excellent bio-availability in plants, wherein it can optimally induce regulation and/or stimulation of growth. More by preference, said moieties are randomly distributed following the ratio a:b:c, wherein:
a+b+c>20;
b/(a+b+c)<0.10; and
c/(a+b+c)<0.10;
   and wherein d=1, 2 or 3.

Even more by preference, a+b+c>100, a+b+c>250, a+b+c>500, most by preference 600<a+b+c<1000.

In a further or another embodiment, the composition comprises a water-insoluble solvent and water, wherein said composition is an oil-in-water emulsion having an oil to water ratio of between 1:20 to 20:20.

As described herein, an “emulsion” relates to a mixture of two or more liquids that are normally immiscible due to liquid-liquid separation. Emulsions are thus part of a more general class of two-phase systems called “colloids”. Practically, in an emulsion one liquid (the dispersed phase) is dispersed in the other (the continuous phase). Emulsions generally comprise two main classes, and are either oil-in-water or water-in-oil. The emulsions of the present invention concern oil-in-water emulsions, thus emulsions in which the continuous phase is water and the dispersed phase is oil-based.

The present invention now succeeds at further improving bio-availability of the ferulated chitosan composition as described herein, which therefore excellently inhibits the phytotoxic effects of herbicides and/or fungicides. In particular, as ferulated chitosan has a low solubility in water, the invention provides for a stable emulsion in which the ferulated chitosan does not precipitate, even during long-term storage. Whereas emulsions are generally sensitive to shear forces during manufacture or during dilution and/or mixing of the formulation with water, the present formulation furthermore has excellent stability during dilution and/or mixing in water within the oil to water ratio as herein described.

In a further or another embodiment, the water-insoluble solvent has a concentration of between 5.00 and 50.00 wt. % based on the total weight of said composition. The water-insoluble solvent is thus a major contributor in the oil phase of the emulsion. As such, it serves as a carrier for the ferulated chitosan, and aids in stabilization of the emulsion, homogeneous distribution of the ferulated chitosan in the composition, as well as improving bio-availability of the ferulated chitosan to plants, thereby allowing optimal effect towards inhibiting the phytotoxic effect of herbicides and/or fungicides. By preference, the water-insoluble solvent has a concentration of between 5.00 and 40.00 wt. %, more by preference of between 5.00 and 30.00 wt. %, between 5.00 and 20.00 wt. %, even more by preference of between 5.00 and 10.00 wt. % based on the total weight of the composition.

In some embodiments, the composition comprises a rheological modifier, wherein said rheological modifier has a concentration of between 0.10 and 30.00 wt. % based on the total weight of said composition. The rheological modifier aims to increase the viscosity of the composition, thereby further increasing long-term emulsion stability, while avoiding creaming of the emulsion components and reducing coalescence. It is submitted that also bio-availability of the ferulated chitosan was further improved by influence of the rheological modifier, thereby allowing optimal bioavailability to targeted plants, wherein phytotoxic effects caused by herbicides and/or fungicides are optimally reduced. By preference, the rheological modifier has a concentration of between 0.10 and 20.0 wt. %, more by preference of between 0.10 and 5.00 wt. %, even more by preference of between 0.10 and 1.0 wt. %.

According to a further or another embodiment, the composition comprises a hydrophilic and/or a lipophilic surfactant, wherein said hydrophilic and/or lipophilic surfactant have a concentration of between 0.01 and 10.00 wt. % based on the total weight of said composition. The term “surfactant” herein relates to organic compounds that are amphiphilic, indicating that they contain both hydrophobic groups and hydrophilic groups. Therefore, a surfactant contains both a water-insoluble (or oil-soluble) component and a water-soluble component. As a result of their specific structure, surfactants will diffuse in water and adsorb at interfaces between an oil and a water phase.

The hydrophile-lipophile balance (HLB) number is used as a measure of the ratio of hydrophilic and lipophilic groups in a surfactant. It is generally a value between 0 and 60 defining the affinity of a surfactant for water or oil. HLB numbers are calculated for nonionic surfactants, and these surfactants have numbers ranging from 0-20. HLB numbers >10 have an affinity for water (hydrophilic) and number <10 have an affinity of oil (lipophilic). Ionic surfactants have recently been assigned relative HLB values, allowing the range of numbers to extend to 60.

The surfactants as described herein facilitate a better surface coverage (e.g. plant leaves wetting), improved spreading and maintaining hydration during the application on plants, e.g. by spraying on plant leaves. The surfactants thus allow to further stabilize the emulsion of the present composition, which can be effectively used to reduce phytotoxic effects caused by herbicides and/or fungicides, and which has an exceptionally high bio-availability in plants. By preference, said hydrophilic and/or lipophilic surfactant have a concentration of between 0.01 and 9.00 wt. %, of between 0.01 and 8.00 wt. %, of between 0.01 and 7.00 wt. %, of between 0.01 and 6.00 wt. %, or of between 0.01 and 5.00 wt. % based on the total weight of said composition. Even more by preference, said hydrophilic and/or lipophilic surfactant have a concentration of between 0.05 and 5.00 wt. %, of between 0.10 and 5.00 wt. %, of between 0.15 and 5.00 wt. %, of between 0.20 and 5.00 wt. %, or of between 0.25 and 5.00 wt. % based on the total weight of said composition.

According to a further or another embodiment, the composition comprises a hydrophilic and a lipophilic surfactant, wherein each of said hydrophilic and said lipophilic surfactant has a concentration of between 0.01 and 10.00 wt. % based on the total weight of said composition. By preference, each of said hydrophilic and lipophilic surfactant has a concentration of between 0.01 and 9.00 wt. %, of between 0.01 and 8.00 wt. %, of between 0.01 and 7.00 wt. %, of between 0.01 and 6.00 wt. %, or of between 0.01 and 5.00 wt. % based on the total weight of said composition. Even more by preference, each of said hydrophilic and lipophilic surfactant has a concentration of between 0.05 and 5.00 wt. %, of between 0.10 and 5.00 wt. %, of between 0.15 and 5.00 wt. %, of between 0.20 and 5.00 wt. %, or of between 0.25 and 5.00 wt. % based on the total weight of said composition.

The water-insoluble solvent according to some embodiments, is a vegetable oil or vegetable oil ester, chosen from the group of linseed oil, rapeseed oil, soybean oil, palm oil, coconut oil, canola oil, sunflower oil, their esters, or combinations thereof.

Said rheological modifier according to some embodiments, is chosen from the group of guar gum, xanthan gum, gellan gum, alginates, cellulose derivatives like hydroxyethylcellulose, methylcellulose, hydroxypropylcellulose, acrylates, poly-esters, polyester block co-polymers, polyamides, polyquaternium emulsions, polyvinyl alcohol, waxes, clays, pyrogenic silica, or combinations thereof.

The rheological modifier as described herein provides the composition with shear thinning and/or thixotropic properties, which allows the composition to be even more efficiently applied to plants. By preference, said rheological modifier is chosen from the group of guar gum, xanthan gum, gellan gum, alginates, or combinations thereof.

According to a further or another embodiment, said hydrophilic surfactant is chosen from the group of Tween 20, Tween 21, Tween 40, Tween 60, Tween 65, Tween 80, Tween 81, Tween 85, PEG 400 monooleate, PEG 400 monostearate, PEGE 400 monolaurate, potassium oleate, polyalkylene oxide block co-polymers, sodium lauryl sulfate, triethanolamine oleate, or combinations thereof.

According to a further or another embodiment, said lipophilic surfactant is chosen from the group of Span 20, Span 40, span 60, Span 65, Span 80, Span 85, Tween 61, glycerol monostearate, or combinations thereof.

According to a further or another embodiment, the composition has a pH of between 4.0 and 7.0. By preference, the composition has a pH of between 5.0 and 6.5.

According to a further or another embodiment, said composition is applied to the targeted plant before, simultaneously with, or after application of a herbicide and/or fungicide.

Compounds reducing the phytotoxicity of a herbicide and/or fungicide towards a targeted plant are generally referred to as a “safener”. Safeners are generally used in three main ways:
seed treatment safeners;
pre-emergence or post-emergence tank mix safeners; and
safeners co-formulated with the herbicide or the fungicide.

Use of the composition as described herein has the additional advantage that all of the above ways of application are possible. To ensure maximum crop safety, safeners that are applied in mixture with the herbicides need to act quicker than the herbicide injury develops. As will be elaborated in the below examples, the described mode of action of ferulated chitosan is very fast, i.e. there is an immediate activation of detoxification routes in crops, which enables it to be applied co-formulated with the herbicide and/or fungicide, as well as separately.

In some embodiments, the composition is applied to the targeted plant simultaneously with a herbicide and/or fungicide, i.e. the composition and the herbicide and/or fungicide are applied as a premix. Said premix comprises the ferulated chitosan composition and the herbicide and/or fungicide in a ratio of between 1:10 and 1:20.000 based on the total weight of the premix.

The ratio of the premix as described herein finds an optimal balance between combating the growth of weeds and or other competing organisms, meanwhile reducing the phytotoxic effects of the herbicide and/or fungicide.

By preference, the ratio between the ferulated chitosan component and the herbicide and/or fungicide is of between 1:25 and 1:15.000, more by preference of between 1:50 and 1:10.000, most by preference of between 1:100 and 1:5.000.

According to some embodiments, said herbicide and/or fungicide is chosen from the group of (1) benzoic acid, (2) caroxylic acid, pyridines, (3) carboxylic acids (acetic acid, citric acid, pelargonic acid), (4) imidazolinone (imazapic, imazamox, imazamethabenz, imazapyr, imazaquin, imazethapyr), (5) sulfonylurea (chlorimuron, chlorsulfuron, foramsulfuron, halosulfuron, iodosulfuron, metsulfuron, nicosulfuron, primisulfuron, prosulfuron, rimsulfuron, sulfometuron, sulfosulfuron, thifensulfuron, trasulfuron, tribenuron, amidosulfuron, azimsulfuron, bensulfuron-methyl, flazasulfuron, flupyrsulfuron-methyl, mesosulfuron-methyl), (6) sulfonylamino-carboynyl-triazolinones (cloransulam, flumetsulam, florasulam), (7) amino acid derivative (glycines, glyphosates), (8) aryloxyphenoxy propionates (clodinafop-propargyl, diclofop-methyl, fluazifop-butyl, quizalofop-p-ethyl), (9) cyclohexanediones (clethodim, profoxidym, sethoxydim, tralkoxydim), (10) phenylpyrazoline (pinoxaben), (11) dinitroanilines, (12) carbamates and thiocarbamates (phenmedipham, prosulfocarb, triallate), (13) chloroacetamides and oxyacetamides (metazachlor, pethoxamide, flufenacet), (14) triazines, (15) triazinones (metamitron, metribuzin), (16) uracil (lenacil), (17) nitrile (bromoxynil), (18) triketone (mesotrione), (19) phosphonic acid (glufosinate-amonium), (20) diphenyl ether (aclonifen), (21) triazinone (trifludimoxazin), (22) benzofuran (ethofumesate), (23) benzothiadiazinone (bentazon), (24) phenoxy-carboxylic-acid (2.4-d, mcpa), (25) strobilurin (azoxystrobine, pyraclostrobin), (26) phenylpyrrole (fludioxynil), (27) phenylamide (metalaxyl, metalaxyl-m), (28) benzimidazole (thiabendazole, thiophanate-methyl), (29) triazole (difenoconazole, tebuconazole, myclobutanil, metconazole), (30) anilopyrimidine (cyprodinil), (31) cyanoacetamide-oxime (cymoxanil), (32) pyrazole (sedaxane), (33) carbamate (thiram), (34) pyrazolium (fluxapyroxad), (35) phenylpyridinamine (fluazinam), (36) phenylurea (pencycuron), (37) chloronitrile (chlorothanlonil), (38) oxathiin-carboxamide (carboxime), (39) dithiocarbamates (mancozeb), (40) dicarboximide (iprodione), (41) amide (benzovindiflupir), (42) carboxamide (pydiflumetofen), (43) mandelamide (mandipropamide), (44) benzamide (fluopyram), (45) pyrazole (fluxapyroxad), (46) carboxamide (boscalid), (47) morpholine (fenpropimorph), (48) inorganic compound (copper based products), or combinations thereof.

In some embodiments, said herbicide is chosen out of any one of the compounds from groups (1) to (24), or combinations thereof. In some embodiments, said fungicide is chosen out of any one of the compounds from groups (25) to (48), or combinations thereof.

The ferulated chitosan is optimally capable of inhibiting any phytotoxic effects resulting from the use of said herbicidal and/or fungicidal compounds, which allows for optimal plant growth regulation and/or stimulation and which allows for the optimal inhibition of competing organisms, such as weeds or fungi.

Carboxylic acids are according to some embodiments chosen from the group of acetic acid, citric acid, pelargonic acid, or combinations thereof. According to some embodiments, imidazolinone is a compound chosen from the group of imazapic, imazamox, imazamethabenz, imazapyr, imazaquin, imazethapyr, or combinations thereof. Sulfonylurea according to some embodiments, is chosen from the group of chlorimuron, chlorsulfuron, foramsulfuron, halosulfuron, iodosulfuron, metsulfuron, nicosulfuron, primisulfuron, prosulfuron, rimsulfuron, sulfometuron, sulfosulfuron, thifensulfuron, trasulfuron, tribenuron, or combinations thereof. According to some embodiments, sulfonylamino-carboynyl-triazolinones are chosen from the group of cloransulam, flumetsulam, or combinations thereof. Amino acid derivatives according to some embodiments are chosen from glycines, glyphosates, or combinations thereof.

According to some embodiments, said applying the composition to the targeted plant comprises foliar application through spraying of the composition on leaves of the targeted plant. Spraying of the composition is a particularly favorable method of application as it allows homogeneous distribution of the composition over the targeted plants. Furthermore, spraying is a very fast method of distributing the composition, allowing the treatment of a large surface area of plants. Bio-availability of the ferulated chitosan through foliar spraying to targeted plants is exceptionally large.

According to a further or another embodiment, said applying the composition to the targeted plant comprises soil application through spraying and/or drenching of the composition on the soil in contact with said targeted plant. This application method alternatively or additionally allows for the easy application of the composition on a large amount of plants, meanwhile ensuring a homogeneous distribution and optimal bio-availability of the ferulated chitosan towards the targeted plants.

According to some embodiments, said applying the composition to the targeted plant comprises seed application through adding the composition on seed treatment formulations. The herein described application method relates to the treatments of seeds of a targeted plant and allows for increased seed germination and seedling growth.

In another aspect, the invention relates to a method for the production of ferulated chitosan comprising the steps of:
dispersing chitosan in a solution with a pH between 5.0 and 9.0 and adding ferulic acid and an enzyme of the family of multi-copper oxidases, obtaining a mixture;
allowing the mixture to enzymatically react;
recovering a precipitate from the reacted mixture.

In an embodiment, the method for the production of ferulated acid comprises the steps of:
dispersing powdered chitosan in a solution with a pH between 5.0 and 9.0, preferably with a pH between 6.0 and 8.0, more preferably a phosphate buffer solution with a pH of 6.8-7.2;
adding ferulic acid to the solution with chitosan, preferably a solution of 2-10 mM of ferulic acid, more preferably a solution of 4.5-5.5 mM of ferulic acid in methanol;
adding an enzyme of the family of multi-copper oxidases (MCOs) to the solution with chitosan and ferulic acid, preferably the enzyme is laccase, more preferably a laccase solution of 0.5-2.0 U/mL is added;
allowing the solution to enzymatically react, preferably at a temperature of 15-40° C. and under agitation, during 1-24 hours, more preferably at 25-35° C. and under agitation at 100-140 rpm, during 3-5 hours;
recovering a precipitate, preferably by centrifugation;
optionally washing the recovered precipitate with a buffer, preferably with a phosphate buffer;
optionally washing with an alcohol the washed precipitate, preferably two washing steps with two different methanol solutions, more preferably the two methanol solutions have a concentration of 45-55% and 85-95%, respectively.

Enzymatic production of ferulated chitosan is desired over chemical synthesis. Enzymes improve the selectivity and reaction speed of the reaction and are easy to use. Fewer impurities are obtained. The obtained precipitate contains high concentrations of ferulated chitosan. In an embodiment, the obtained ferulated chitosan is used according to the first aspect.

In another aspect, the invention relates to ferulated chitosan obtainable according to the second aspect and used according to the first aspect.

### EXAMPLES

The invention is further described by the following non-limiting examples which further illustrate the invention, and are not intended to, nor should they be interpreted to, limit the scope of the invention.

### Example 1: Compositions Comprising Ferulated Chitosan

The tables below contain example compositions comprising a ferulated chitosan according to the first aspect of the present invention. The compositions provided therein are particularly suited for use in reducing phytotoxic effects of herbicides and/or fungicides in targeted plants.

TABLE 1
Ferulated chitosan composition A

| Component | Function | Concentration | |
|---|---|---|---|
| Ferulated chitosan | Active ingredient | 0.10 | wt. % |
| Soybean oil | Water-insoluble solvent | 8.00 | wt. % |
| Tween 20 | Hydrophilic surfactant | 1.00 | wt. % |
| Xanthan gum | Rheological modifier | 1.00 | wt. % |
| Water | Solvent | 89.90 | wt. % |

TABLE 2
Ferulated chitosan composition B

| Component | Function | Concentration | |
|---|---|---|---|
| Ferulated chitosan | Active ingredient | 1.00 | wt. % |
| Rapeseed oil | Water-insoluble solvent | 14.00 | wt. % |
| Tween 80 | Hydrophilic surfactant | 2.00 | wt. % |
| Gellan gum | Rheological modifier | 2.00 | wt. % |
| Water | Solvent | 81.00 | wt. % |

TABLE 3
Ferulated chitosan composition C

| Component | Function | Concentration | |
|---|---|---|---|
| Ferulated chitosan | Active ingredient | 5.00 | wt. % |
| Linseed oil | Water-insoluble solvent | 10.00 | wt. % |
| Span 20 | Lipophilic surfactant | 1.00 | wt. % |
| Methylcellulose | Rheological modifier | 1.00 | wt. % |
| Water | Solvent | 83.00 | wt. % |

TABLE 4
Ferulated chitosan composition D

| Component | Function | Concentration | |
|---|---|---|---|
| Ferulated chitosan | Active ingredient | 6.00 | wt. % |
| Sunflower oil | Water-insoluble solvent | 20.00 | wt. % |
| PEG 400 monostearate | Hydrophilic surfactant | 0.75 | wt. % |
| Glyceryl monostearate | Lipophilic surfactant | 0.75 | wt. % |
| Guar gum | Rheological modifier | 3.00 | wt. % |
| Water | Solvent | 69.50 | wt. % |

### Example 2: Two-Component Compositions Comprising Ferulated Chitosan and a Herbicide and/or Fungicide

The tables below contain example compositions comprising both a ferulated chitosan and a herbicide and/or fungicide according to the second aspect of the present invention. Presently known safeners mainly fall in the following categories having a plentitude of limitations:
Adsorbents, i.e. substances which were early used to physically shield the crop seed from contact with the herbicide that otherwise would cause injury. Disadvantages include: (i) requirement for the use of activated carbon, lignin by products, ion ex-change resins, and various clays, (ii) requirements of an application technique different from that used for herbicide application, (iii) high expense and inadequate control of weeds;
Chemicals with antagonist interaction, i.e. chemicals that may be applied with the herbicide to protect the crop plant against herbicide injury. This approach include the use of chemicals such as naphthalic anhydride, di-chlormid (2,2-dichloro-N,N-diallylacetamide), oxime ether compounds (cyometrinil, oxabetrinil, and CGA-15281), thiazole-carboxylic acid (flurazole), fenclorim, pyrimidine triazole derivatives etc.
Disadvantages include: (i) the safener's activity is determined by selection of the herbicide and the crop, (ii) some of these compounds offer protection to weeds and are thus limited to seed application, (iii) some compounds are not compatible with the herbicide and cannot be co-formulated in a product or even applied in the same tank mix, (iv) at high application rate, some compounds can injury of the targeted crops (e.g. stunning and chlorosis), (v) unknown efficacy and possibly high toxicological impact for the environment.

The compositions exemplified hereunder are particularly suited for combating weed growth in a targeted crop. The ferulated chitosan herein serves as a safener, i.e. aids in inhibiting the phytotoxic effects of herbicides and/or fungicides in the targeted plant.

TABLE 5
Ferulated chitosan and herbicide composition I

| Component | Function | Concentration | |
|---|---|---|---|
| Ferulated chitosan | Safener agent | 20.00 | wt. % |
| composition C (Table 3) | | | |
| Imazamox | Herbicide | 1.80 | wt. % |
| Metazaclor | Herbicide | 38.00 | wt. % |
| Tween 80 | Hydrophilic surfactant | 20.00 | wt. % |
| Water | Solvent | 20.20 | wt. % |

TABLE 6
Ferulated chitosan and herbicide composition II

| Component | Function | Concentration |
|---|---|---|
| Ferulated chitosan | Safener agent | 18.00 wt. % |
| composition C (Table 3) | | |
| Pofoxydim | Herbicide | 20.00 wt. % |
| Liquid hydrocarbon | Solvent | 62.00 wt. % |

TABLE 7
Ferulated chitosan and fungicide composition III

| Component | Function | Concentration |
|---|---|---|
| Ferulated chitosan | Safener agent | 50.00 wt. % |
| composition C (Table 3) | | |
| Tetraconazole | Fungicide | 20.50 wt. % |
| Other ingredients | Dispersants | 29.50 wt. % |

### Example 3: Preparation and Characterization of Ferulated Chitosan

The present example merely serves to show a possible method of producing a ferulated chitosan, and should not be considered limiting for the present invention. In this example, ferulated chitosan was produced by enzymatic grafting, in particular by laccase enzymatic grafting.

Ferulated chitosan is produced following the steps:
1. Dispersing powdered chitosan in a phosphate buffer of pH 7.0;
2. Adding a solution of 5 mM of ferulic acid (in methanol);
3. Adding a solution of 1 U/mL of laccase;
4. Allowing the mixture to enzymatically react at a temperature of 30° C. and under agitation at 120 rpm, during 4 hours;
5. Recovering the resulting ferulated chitosan by centrifugation;
6. Purifying the ferulated chitosan by washing with phosphate buffer in order to remove laccase, and subsequent washing with 50% and 90% methanol solutions to remove unreacted ferulic acid.

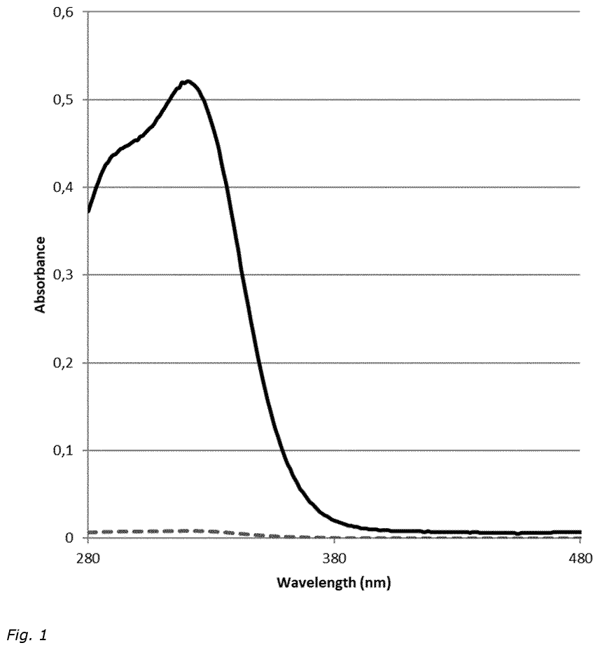

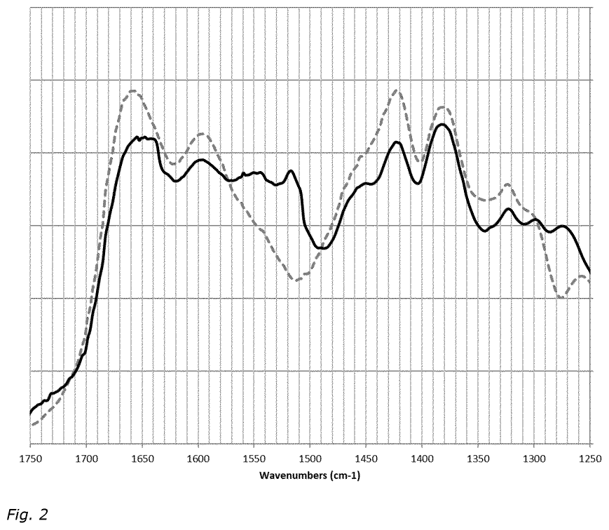

In order to characterize the final product, both unmodified chitosan and ferulated chitosan samples were dissolved at 0.05% (w/v) in aqueous acetic acid (1%) at pH 4.5 and the UV spectrum was recorded using spectrophotometer scanning at 280-480 nm. Additionally, an FT-IR analysis were carried out by the potassium bromide (KBr) pellet method with a Perkin-Elmer Spectrum One FT-IR spectrometer (Norwalk, USA) in the range of 400-4000 cm-1 with 120 scans. Results are shown in FIGS. 1 and 2. FIG. 1 herein shows the UV spectra comparing the unmodified chitosan (dotted line) and the ferulated chitosan (full line) following the present invention. A large band of absorbance around 320 nm is observed, demonstrating that ferulic acid successfully reacted with the chitosan. Furthermore, FIG. 2 shows the FTIR spectra comparing the unmodified chitosan (dotted line) and the ferulated chitosan (full line) following the present invention. a shift of the maximum of the band at 1660 cm-1 to 1645 cm-1 characteristic of Schiff base formation was observed and new bands appear at 1540 cm-1 and 1520 cm-1, demonstrating the successful reaction of ferulic acid with the chitosan.

### Example 4: Preparation of a Foliar Spraying Formulation Comprising Ferulated Chitosan

As the absorption of an active ingredient by the plant surface involves a series of complex processes and events, active ingredients are formulated in order to be effectively applied on the field and delivered to the target plant for maximum efficacy. The formulation as exemplified herein furthermore shows excellent stability and shelf-life stability.

A stable and homogeneous formulation containing 0.01 wt. % of ferulated chitosan is prepared as follows:
1. Providing the aqueous phase, by mixing:
   1 part of 1% solution of ferulated chitosan in a phosphate buffer at pH 5.7;
   93 parts 0.5% Xanthan gum solution; and
   1 part of Tween 20;
2. Providing the oil phase: soybean refined oil;
3. Preparing an oil-in-water emulsion by gradually adding the oil phase to the aqueous phase, meanwhile homogenizing the mixture thereof by means of a homogenizer (Ultra Turrax, model T25, IKA Works, USA) at 24,000 rpm for 5 min.

Stability of the resulting composition is characterized following CIPAC method 46.1.3 in the following table.

TABLE 8
Characterization of the composition comprising ferulated chitosan

| | Stability | pH |
|---|---|---|
| Initial | Stable | 5.5 |
| 14 days at 4° C. | Stable | 5.5 |
| 14 days at 54° C. | Stable | 5.5 |

It is further exemplified in the table below that the composition has a favorable surface tension during further dilution in water, and remains stable herein. Determination of surface tension is based on the Wilhelmy plate method.

TABLE 9
Surface tension of the composition comprising ferulated chitosan.

| | Surface tension | |
|---|---|---|
| Dilution factor | (mN · m⁻¹) | Standard deviation |
| Water | 73.7 | 0.2 |
| 0.001 | 54.4 | 0.1 |
| 0.002 | 54.2 | 0.3 |
| 0.004 | 53.5 | 0.2 |
| 0.006 | 52.2 | 0.2 |
| 0.008 | 50.1 | 0.1 |
| 0.010 | 48.1 | 0.2 |

### Example 5: Effect of Foliar Application in Arabidopsis Plants

Arabidopsis thaliana seeds were sown in soil and the pots were kept for four days for vernalization (4° C. in darkness) for uniform seed germination. Afterward, the pots were kept in a growth chamber in a 12 h light (21° C., 60% relative humidity)/12 h dark (16° C., 70% relative humidity) cycle. At least 20 developed 30 day-old plants were used for the experiments. Half of the plants were sprayed with a solution comprising ferulated chitosan, the other half was used as control (C). All plant leaves from three biological replicates were snap-frozen in liquid nitrogen. Sample collection was conducted three days after foliar spraying treatment, and transcriptome sequencing was performed.

The table below shows the number of genes which were differentially expressed after treatment with the present composition. Only genes dysregulated with fold times>2 in relation to control were considered.

TABLE 10
Number of genes differentially expressed in Arabidopsis after
foliar spraying with a composition comprising ferulated chitosan

| | Number | Differentially |
|---|---|---|
| | of genes | expressed genes (%) |
| Up-regulated | 3871 | 55.1 |
| Down-regulated | 3156 | 44.9 |
| Total | 7027 | |

These above results demonstrated that foliar application of a composition comprising ferulated chitosan on plants has a high impact on plant transcriptome. To gain insights into the molecular mechanisms involved in bioactivity of ferulated chitosan, a Gene Ontology (GO) enrichment analysis of the differentially expressed genes (DEG) was performed. A selection of them are summarized in the table below.

TABLE 11
Number of differentially regulated genes directly
associated to plant growth and development process.

| | | | Percentage |
|---|---|---|---|
| | | Number | of asso- |
| | | of | ciated genes |
| | ID | genes | (%) |
| vegetative to reproductive | GO: 0010228 | 13 | 6.44 |
| phase transition of meristem | | | |
| photoperiodism, flowering | GO: 0048573 | 7 | 6.60 |
| seed germination | GO: 0009845 | 8 | 4.88 |
| response to inorganic | GO: 0010035 | 49 | 5.19 |
| substance | | | |
| regulation of shoot system | GO: 0048831 | 14 | 6.73 |
| development | | | |
| pigment metabolic process | GO: 0042440 | 13 | 6.91 |

These results demonstrated that among the differentially regulated genes, a significant number of them are associated with biological processes linked to the regulation of plant growth and development. It is thereby shown that treatment of Arabidopsis with a composition comprising ferulated chitosan has a major influence in plant growth regulatory processes.

Among the genes differentially expressed in Arabidopsis after foliar spraying of a composition comprising ferulated chitosan, there are furthermore numerous genes involved in detoxification, as exemplified in the below table.

TABLE 12
Differentially regulated genes associated
to plant detoxification processes.

| | | |
|---|---|---|
| | | Ferulated |
| | | chitosan/ |
| | | Control |
| ID | Annotation | (FKM ratio) |

Glutathione S-transferase

| | | |
|---|---|---|
| AT5G17220.1 | glutathione S-transferase phi 12 | 4.9 |
| AT2G02390.4 | glutathione S-transferase zeta 1 | 3.4 |
| AT1G02950.2 | glutathione S-transferase F4 | 2.4 |
| AT3G09270.1 | glutathione S-transferase TAU 8 | 2.1 |
| AT2G02390.1 | glutathione S-transferase zeta 1 | 2.0 |

Cytochrome P450

| | | |
|---|---|---|
| AT3G20120.4 | cytochrome P450% 2C family 705% 2C | 4.1 |
| | subfamily A % 2C polypeptide 21 | |
| AT1G13080.2 | cytochrome P450% 2C family 71% 2C | 4.0 |
| | subfamily B % 2C polypeptide 2 | |
| AT3G20090.1 | cytochrome P450% 2C family 705% 2C | 2.7 |
| | subfamily A % 2C polypeptide 18 | |
| AT3G03470.1 | cytochrome P450% 2C family 87% 2C | 2.4 |
| | subfamily A % 2C polypeptide 9 | |
| AT3G26290.1 | cytochrome P450% 2C family 71% 2C | 2.2 |
| | subfamily B % 2C polypeptide 26 | |
| AT3G26280.2 | cytochrome P450% 2C family 71% 2C | 2.1 |
| | subfamily B % 2C polypeptide 4 | |
| AT3G20080.3 | cytochrome P450% 2C family 705% 2C | 2.1 |
| | subfamily A % 2C polypeptide 15 | |

Glucosyltransferase

| | | |
|---|---|---|
| AT5G54060.1 | UDP-glucose:flavonoid 3-o- | 7.3 |
| | glucosyltransferase | |

It is submitted that plants have the unique capability of stimulating selective signaling pathways in response to diverse stimuli, including natural and synthetic compounds. Subsequently, plants are able to activate specific defense and/or detoxification mechanisms in order to survive and/or adapt in response to such stimuli. Such defense and/or detoxification mechanisms include adapting the plant metabolism in order to grow under the presence of xenobiotic substrates, to metabolize such xenobiotic substrates, and/or to transport and compartmentalize non-phytotoxic, polar metabolites. As shown in the above table, among the differentially upregulated genes by foliar spraying of a composition comprising ferulated chitosan, a significant number of said genes potentially encode important detoxification enzymes including oxidative enzymes, transferases and vacuolar transporter proteins. This list of genes is consistent with previous studies showing induction of individual components of the cellular detoxification machinery by herbicide safeners in dicots, including Arabidopsis. These results demonstrate that ferulated chitosan induces the expression of key genes to enhance plant tolerance to stress generated by exogenous molecules, such as herbicides.

### Example 6: Effect on the Activity of Detoxifying Enzymes

It is submitted that plants have developed sophisticated mechanisms to recognize external signals allowing them to respond appropriately to environmental conditions, although the degree of adjustability or tolerance to specific stresses differs from species to species. For example, overproduction of reactive oxygen species (ROS) is enhanced under heat stresses, which can cause oxidative damage to plant macromolecules and cell structures, leading to inhibition of plant growth and development, or to death. In response thereto, antioxidant defense mechanism which can detoxify ROS are present in plants. A major hydrogen peroxide detoxifying system in plant cells is the ascorbate-glutathione cycle, in which ascorbate peroxidase (APX) enzymes play a key role catalyzing the conversion of H₂O₂ into H₂O, using ascorbate as a specific electron donor.

An experiment was carried out in pea plants (variety Gotivskyi). Plants were grown at an average temperature of 30° C., which negatively impacted plant growth and yield. An experimental design with 4 replicates was applied, wherein seeds were sown at a density of 800 seeds per m², in plots of 10 m². In total 12 plots were randomized.

For foliar application of ferulated chitosan, plants were sprayed at end of budding (GS 59). The spraying composition comprised a ferulated chitosan formulation, mixed with spraying adjuvant Actirob B (Bayer Cropscience). The mixture was subsequently applied once or twice a month at the end of flowering (GS 69).

Plants were sampled for carotenoids and chlorophyll content and antioxidant enzymes activity (APX). Yield was determined after harvesting with a plot combine harvester. For biochemical analysis, 5 plants from each replicate of each treatment were taken. Upper green healthy leaves were collected, combined for each treatment, frozen in liquid nitrogen on the field and used for analysis in the lab. Chlorophyll content was estimated after extraction in dimethyl sulfoxide according to Wellburn (1999). Chloroplasts were isolated as described in (Sokolovska-Sergienko et al., 2012). Ascorbate peroxidase (APX) activity in isolated chloroplasts was determined by measuring concentration of ascorbate in the presence of hydrogen peroxide according to Chen and Asada (1989).

TABLE 13
Effect of the foliar application of ferulated chitosan on chlorophyll,
carotenoids content, APX activity and yield of pea plants

| | | | Ascorbate | |
|---|---|---|---|---|
| | | | peroxidase | Yield |
| | | | (APX in | (recalculated |
| | Chlorophyll | Carotenoids | chloroplasts of | at standard |
| | content | content | leaves, mmol | seed humidity |
| | (mg/g FW) | (mg/g FW) | Asc/mg Chl h) | 14%, t/ha) |
| Control | 1.07 ± 0.08 | 0.22 ± 0.05 | 795 ± 19 | 1.40 ± 0.15 |
| Foliar | 1.32 ± 0.08 | 0.28 ± 0.01 | 1170 ± 95 | 1.90 ± 0.24 |
| application | | | | |
| once a month | | | | |
| Foliar | 1.58 ± 0.10 | 0.32 ± 0.01 | 1182 ± 37 | 2.14 ± 0.23 |
| application | | | | |
| twice a month | | | | |

The results shown in the table above illustrate the effect of the foliar application of ferulated chitosan on pea plants growing under heat stress. It is shown that application of ferulated chitosan enhanced the accumulation of ROS detoxifying APX enzymes. The inhibition of the phytotoxic effect generated by ROS allows a better growth and yield of the crop under these stressful conditions, which is substantiated by the chlorophyll and carotene content being higher in the treated plants.

### Example 7: Effect on Phytotoxicity of Herbicides in Rice Plants

Rice is conventionally grown by transplanting or by wet direct seeding under a lowland flood irrigated system. Weed however imposes serious threat to the productivity of rice by exerting competition with the rice crop for light, nutrients, moisture and other resources. Thus, having an effective weed management system in place is crucial for obtaining high crop yield.

It is submitted that known herbicides control the growth of weed very effectively, and are able to increase the yield of rice cultivation. Nonetheless, indiscriminate use of herbicides potentially causes the development of herbicide resistance in weeds, and can cause the occurrence of phytotoxicity in rice plants. In particular, phytotoxicity may occur in crop plants if inappropriate herbicides are selected. Herbicides which are commonly used for rice cultivation are e.g. Pretilachlor, Bispyribac sodium, Propanil, Thiobencarb, Fenoxopro-p-ethyl, Quinclorac and Bentazon/MCPA. Although these herbicides often cause no severe injury to the rice plants under aerobic soil conditions, rice plants may suffer injuries such as leaf chlorosis and growth stunting during 7 to 14 days after application.

The present example illustrates the effect of ferulated chitosan on the phytotoxicity of herbicides in rice plants. A rice (Oryza sativa) field experiment was carried out, designed as randomized complete block (RCB) with eight replications, wherein untreated plots were included in the experimental design. Plots of 30.5 m² were used. The trial was set in an area where rice is commonly cultivated under monocrop system. Oryza sativa cv. “Puntal” was sown on 28 May 2019 in a dose of 180 kg/ha, and was grown under saturated paddy conditions. The trial was set in a field with clay-loam soil.

Application of a composition comprising ferulated chitosan was done by spraying as follows:
application A on 24 Jun. 2019, BBCH-scale of rice plants being between 13 and 21;
application B on 19 Jul. 2019, BBCH-scale of rice plants being between 32 and 37; and
application C on 15 Aug. 2019, BBCH-scale of rice plants being between 33 and 39.

Herbicide treatments were applied on all plots (both control and treated with ferulated chitosan) as follows:
a combination of Clincher (1.5 L/ha), Aura (0.4 L/ha) and Dash (0.5 L/ha) on 24 Jun. 2019; and
a combination of Propanil 48% (1.1 L/ha), Bentazona 48% (2 L/Ha) and MCPA 50 (0.75 L/ha) on 20 Jul. 2019.

All applications were done by foliar application with a water volume of 200 L/ha, a pressure of 304 kPa, by means of six green ALBUZ anti-drift8 nozzles (AVI 110 015). Assessments were conducted at 7, 14, 32, 39, 50, 64, 119 and 142 DAA-A. The evaluated parameters were BCCH stage of the crop, green level on leaves (from 0 to 1), and height of the plant. At 119 DAA-A yield parameters of harvest was evaluated.

TABLE 14
Effect of ferulated chitosan and herbicide application on rice plants

| | State of green (Green seeker) | | | BBCH | Protein | Plant | |
|---|---|---|---|---|---|---|---|
| | 14 | 25 | 12 | status 7 | content | height | Yield |
| | DDA-A | DDA-B | DDA-C | DDA-A | (%) | (cm) | (T/ha) |
| Control | 0.46 | 0.56 | 0.66 | 17 | 8.78 | 76.39 | 7.66 |
| (Herbicides only) | | | | | | | |
| Foliar application | 0.48 | 0.57 | 0.63 | 19 | 8.87 | 78.90 | 8.27 |
| A (24 Jun. 2019) | | | | | | | |
| Foliar application | 0.50 | 0.55 | 0.66 | 19 | 8.71 | 77.07 | 8.22 |
| AB (24 Jun. 2019 | | | | | | | |
| and 19 Jul. 2019) | | | | | | | |
| Foliar application | 0.50 | 0.62 | 0.63 | 20 | 8.86 | 79.69 | 7.98 |
| BC (19 Jul. 2019 | | | | | | | |
| and 15 Aug. 2019) | | | | | | | |

As shown in the above table, the combined application of herbicides with ferulated chitosan vastly improves the quality of the crop. In the first week after applying the herbicide, the rice plants that had also been treated with the ferulated chitosan, had advanced 2 or 3 BBCH stages (19,20) in relation to the control plants (17). The protective effect of ferulated chitosan on the inhibition of plant growth induced by the application of the herbicide is also reflected at the end of the harvest with a higher yield and with larger plants.

### Example 8: Effect on Phytotoxicity of Herbicides in Lemna minor Plants

The present example shows the effect on phytotoxicity of herbicides in rice plants. The experiment was carried out in Lemna minor growing under in vitro conditions. A stock culture of Lemna minor was maintained on modified Hoagland medium in a controlled environment. The pH of the medium was adjusted to 6.0, and the plants were grown under static conditions in a plant growth chamber at 25±2° C., in a light/dark regime of 16 h/8 h.

An experiment was conducted, using fronds free from any visible chlorosis which were taken from the stock cultures and exposed to diverse treatments. For each treatment, six repetitions with three fronds per repetition as the initial frond number were used. Individuals fronds were transferred to a 12-well multiplate containing Hoagland medium (control), Hoagland medium containing 10 mg/L of ferulated chitosan, chitosan or ferulic acid, Hoagland medium containing 10 mg/L of herbicide (a systemic selective herbicide used in post-emergence, Profoxydim C24H32ClNO4S), and Hoagland medium containing 10 mg/L of the herbicide Profoxydim in combination with 10 mg/L of ferulated chitosan, chitosan or ferulic acid. The multiplate was covered with a transparent cover to prevent evaporation. The relative growth was calculated after one week of incubation in the described conditions, and the survival rate was evaluated.

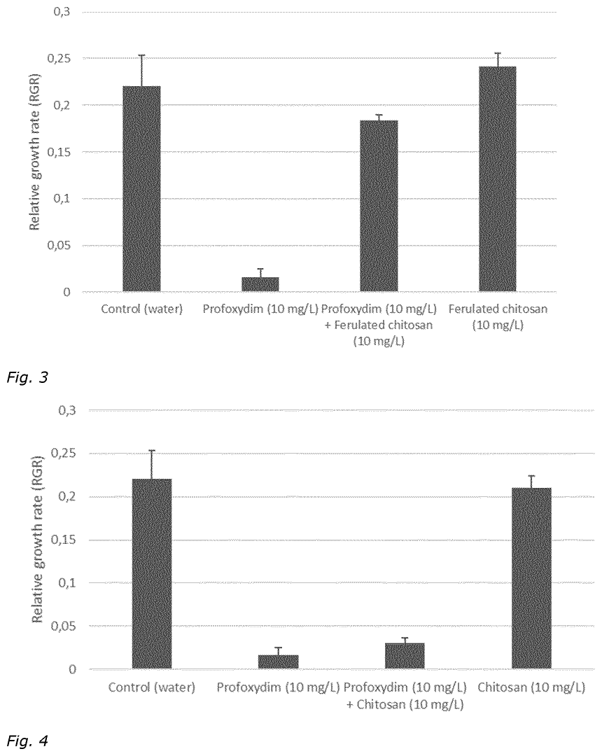

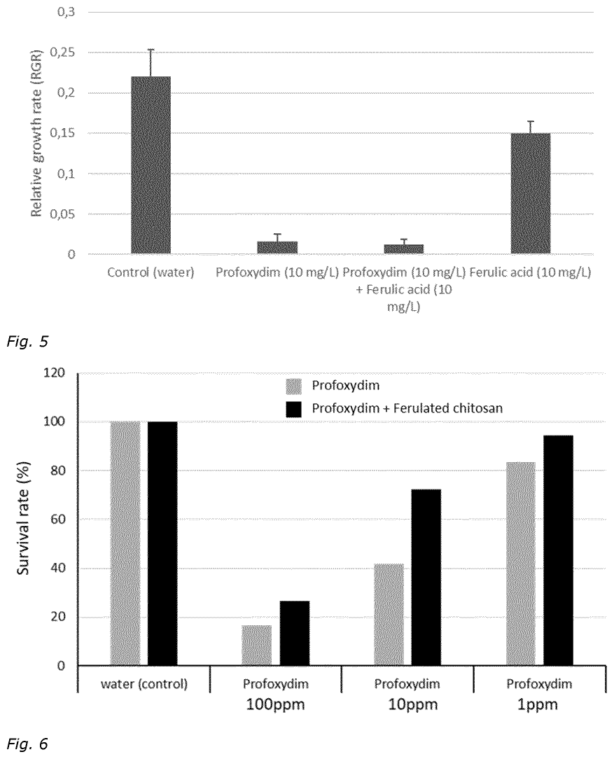

Results are shown in FIG. 3-5 respectively showing the relative growth rate of Lamina minor plants treated with a herbicide and with a composition comprising ferulated chitosan according to an embodiment of the present invention, with chitosan, and with ferulic acid. In FIG. 6 the survival rate of Lemna minor is shown for plants treated with a herbicide alone (light grey) or with a combination of a herbicide and a ferulated chitosan according to an embodiment of the present invention.

In FIGS. 3-5, it is shown that chitosan and ferulated chitosan did not show significant changes in the relative growth rate of Lemna minor plants (no phytotoxicity), however ferulic acid is hindering Lemna minor growth (phytotoxicity). Furthermore, the herbicide at 10 mg/L drastically reduced the RGR of the plants (phytotoxicity). It was surprisingly found that a combination of 10 mg/L of the herbicide Profoxydim with ferulated chitosan significantly reduced the phytotoxic effect of the herbicide enabling the plant to have a normal relative growth rate.

Neither chitosan nor ferulic acid in combination with the herbicide showed this protective effect. From FIG. 6, it is also shown that this protective effect of the combination of ferulated chitosan and the herbicide is observed at different concentrations of the herbicide.

### Example 9. Effect of a Two-Component Composition Comprising Ferulated Chitosan and Fungicide on Growth Yield

The use of fungicides in soybeans and many other crops is an almost necessary condition to guarantee adequate yields in case of infection with pathogenic fungi. However, plant injury (phytotoxicity) may occur when chemicals are employed to protect plants, reducing yield and harvest quality.

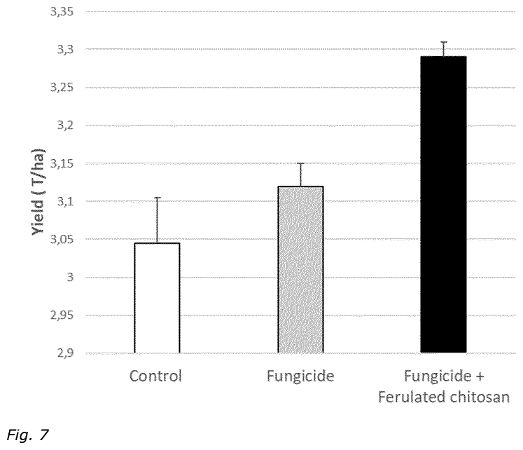

A soybean field trial was conducted, wherein all procedures from planting to harvesting were done according to common practices. A single application of fungicide alone, or in combination with ferulated chitosan in the tank mix, were applied at R3 during pod formation. The experiment was arranged in a completely randomized design with six replicates per treatment. FIG. 7 shows the impact on final soybean yields of both treatments.

In the present example, it is shown that ferulated chitosan can be used in combination with fungicides to boost plant yields.

### Example 10. Effect on Stress Response Induced by Herbicides in Plants

In some plants, anthocyanin accumulation is a typical symptom of phytotoxicity after the application of different herbicides, and it has been associated to plant growth reduction. A phenomics approach was pursued to investigate the effect of ferulated chitosan in combination with a selection of herbicides on the accumulation of anthocyanin in the plant model Lemna minor. In light of the present invention, “phenomics” need to be interpreted as the technology which allows high throughput and multispectral image capturing coupled to an image analysis pipeline. The system is composed of a 6 Mp/16 bit camera mounted on a Cartesian coordinate robot.

Lemna minor plants were grown in a 40 L water tank under laboratory conditions (21° C.). They received a light regime of 12 h light, 12 h dark (Nano Power-Led 5.0, Dennerle, Vinningen, Germany). At daytime regime of the experiment, one pair of leaves was placed in each well of a 96-well plate. The evaluated herbicides are summarized in the table below.

TABLE 15
Evaluated herbicides

| | Herbicide | | |
|---|---|---|---|
| | Resistance | | |
| | Classifica- | Herbi- | |
| Chemical | tion | cide | |
| family | (HRAC) | group | Mechanism of action |
| Profoxydim | A | 1 | Inhibits production of acetyl |
| | | | COA carboxylase (ACCase) |
| Triflusulfuron- | B | 2 | Selective, inhibits amino acid |
| methyl | | | synthesis. Inhibits plant amino |
| | | | acid synthesis - |
| | | | acetohydroxyacid synthase |
| | | | AHAS |
| Phenmediphan | C | 5 | Inhibitors of photosynthesis at |
| | | | photosystem II (PS II inhibitors) |
| Ethofumesate | N | 16 | Selective, systemic, absorbed |
| | | | through emerging shoots and |
| | | | roots. Inhibition of lipid |
| | | | synthesis. |

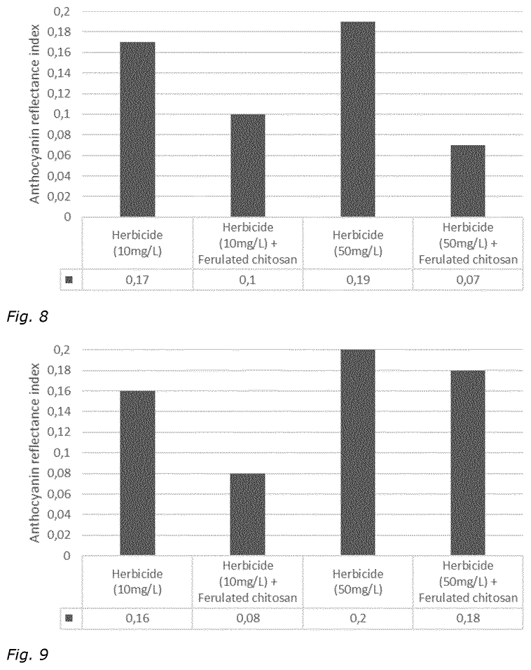

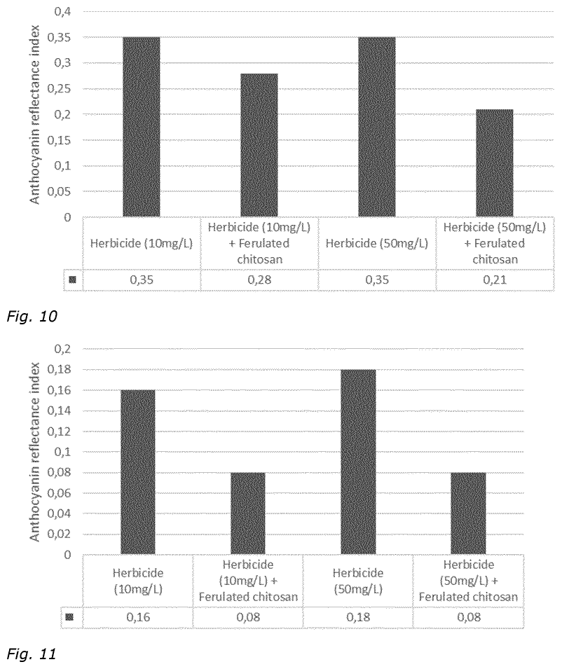

Each well of the 96-well plate was assigned to one of the treatments in a final volume of 300 μL. A pair of leaves of Lemna minor was placed in each well and the well plates were subsequently measured at several time points ranging from 0.15 h to 72 h after treatment. A multispectral imaging platform was used, allowing the visualization of diverse physiological traits in real-time, based on specific absorption, reflection and emission patterns. These include color (RGB) images, anthocyanin levels, chlorophyll (fluorescence) and near infrared images. The modified anthocyanin reflectance index (mARI) was determined using the following formula (Gitelson et al, 2009): mARI=(1ρ550 nm-1ρ710 nm)ρ770 nm wherein ρ550 is the reflectance in the first spectral band, which is maximally sensitive to anthocyanin content; wherein ρ710 is the reflectance in the second spectral band, which is maximally sensitive to chlorophyll content but not sensitive to anthocyanin content; and wherein ρ770 is the reflectance of the third spectral band, which compensates for leaf thickness and density. Image data were analyzed using the Data Analysis tool from Phenovation (Version 5.4.6, Wageningen, The Netherlands). Results are shown in FIGS. 8-11.

Anthocyanins are induced in plant by different stressors, including herbicide molecules. Anthocyanins also mitigate photooxidative injury in leaves by efficiently scavenging free radicals and reactive oxygen species, and consequently they are considered to be a biomarker of plant stress. All the evaluated herbicides induced anthocyanin accumulation in Leman minor plants. Surprisingly, in the presence of ferulated chitosan, the level of anthocyanin induced by the herbicidal molecules were lower than in the treatments with herbicides alone. This clearly demonstrates that ferulated chitosan effectively inhibits the plant phytotoxicity mediated by herbicides.

### Example 11. Effect on Phytotoxicity of Fungicides in Seed Treatment

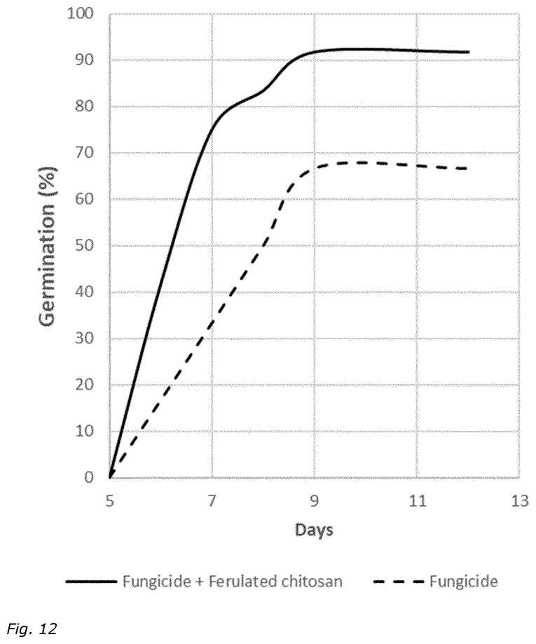

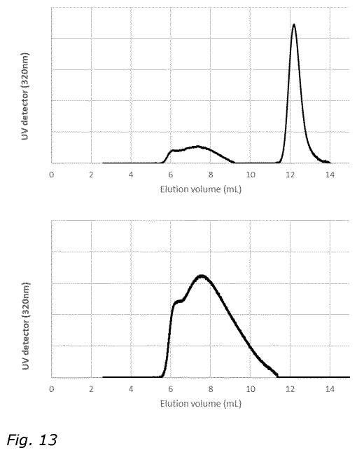

Seeds of corn plant were coated with a flowable concentrate formulation containing a combination of the fungicides metalaxyl, prothioconazole and Triticonazole (fungicide treatment) or a flowable concentrate formulation containing the same combination of the fungicides metalaxyl, prothioconazole, Triticonazole and ferulated chitosan (fungicide+ferulated chitosan treatment). The two flowable concentrate formulations were applied at the industrial recommended rate of 18 mL/kg of treated seeds. After drying, 100 seeds of treated corn seed per treatment were planted on soil and germination evaluated for 2 weeks. The results are shown in FIG. 12.

Fungicide seed treatment is used to control: (a) fungal pathogens that are seed surface-borne, (b) internally seedborne fungal pathogens and (c) soilborne pathogens that attack germinating seeds and seedlings both pre- and postemergence. However, some of these fungicides could show some phytotoxic effect and hinder seed germination. The results shown in FIG. 12 demonstrate that combination of fungicide seed treatment with ferulated chitosan according to the invention hinders the negative effects of those fungicides on corn seeds germination.

### Example 12. Characterization of Ferulated Chitosan by Size Exclusion Chromatography

The present example demonstrates the role of the enzyme in the formation of ferulated chitosan. In this example, a mixture of chitosan and ferulic acid (Chitosan+FA) was prepared as follow: ferulic acid was dissolved by stirring in hot purified water, chitosan was added afterwards. On the other hand, ferulated chitosan was produced by enzymatic grafting as explained in example 3, in particular by laccase enzymatic grafting. The size exclusion chromatographic profiles of both products are compared in FIG. 13.

FIG. 13 shows HPSEC chromatograms of a mixture of chitosan and ferulic acid (Chitosan+FA, upper graph) and ferulated chitosan (down graph) produced by enzymatic grafting as explained in example 3. Column: TSKgel G 4000 PWXL (7.8 mm ID×30 cm), flow rate 0.5 mL/min, mobile phase: Acetic acid 0.3M/Sodium acetate 0.2M, detection UV detector.

In the chromatogram of the mixture of chitosan and ferulic acid (Chitosan+FA, FIG. 13), two peaks are detected: the first peak (5.5 mL-9 mL) corresponds to unmodified high molecular weights chitosan, while ferulic acid separates from the initial mixture during the analysis and elutes later from the column (second peak, 11 mL-14 mL). Chitosan absorbs little in UV (320 nm) so the first peak is smaller, while ferulic acid produces a more intense signal due to its strong absorption in UV at 320 nm.

The profile of ferulated chitosan obtained by enzymatic grafting is completely different: Only a large peak corresponding to modified high molecular weight chitosan with strong absorption in the UV is observed. The intensification in absorption at 320 nm of the modified chitosan is due to the presence of ferulic acid residues attached to the high molecular weight polysaccharide chains. The absence of free residues of ferulic acid in the ferulated chitosan is also explained by the subsequent washing steps with 50% and 90% methanol solutions to remove unreacted ferulic acid during the preparation (Example 3 step 6).

### Example 13. Effect on Phytotoxicity of a Combination of Fungicides and Insecticides in Soybean Seed Treatment

Seeds of soybean plant were coated with a flowable formulation containing a combination of fungicides (metalaxyl, fluxapyroxad, pyraclostrobin and imidacloprid) and insecticides (Imidacloprid, Thiodicarb, Thiamethoxam and Acetamiprid) or a flowable formulation containing the same combination of fungicides and the different compounds as described in table 16. All flowable concentrate formulations were applied at the industrial recommended rate. After drying, 3×100 seeds of treated soybean seed per treatment were planted on soil and germination evaluated after 3 weeks. The results are shown in Table 16.

TABLE 16
Effect of different seed treatment on soybean germination

| Seed treatment | Germination (%) |
|---|---|
| Untreated | 91.4% |
| Fungicides/insecticides | 90.2% |
| Fungicides/insecticides + Chitosan | 92.0% |
| Fungicides/insecticides + Ferulic acid | 85.3% |
| Fungicides/insecticides + Diferulic acid | 90.2% |
| Fungicides/insecticides + Chitosan + Ferulic acid | 88.6% |
| Fungicides/insecticides + Chitosan + Diferulic acid | 91.5% |
| Fungicides/insecticides + Ferulated chitosan | 98.4% |

Seed treatment with fungicides and insecticides is a routine integrated crop management practice for crops; however, some fungicides and insecticides chemicals can hurt the physiological quality of treated seeds and affect the germination and quality of the seedlings. The results shown in table 16 demonstrate that combination of fungicide and insecticides seed treatment with ferulated chitosan according to the invention significantly hinders the negative effects of those pesticides on soybean seeds germination. Neither the combination of pesticides with chitosan, ferulic acid or oligomers of ferulic acid, nor the simple combination of chitosan with ferulic acid or oligomers of ferulic acids does not show the same effectiveness as ferulated chitosan in reducing the phytotoxicity of pesticides.

1. Use of a composition for reducing the phytotoxicity of a herbicide and/or fungicide towards a targeted plant, said composition comprising a ferulated chitosan, wherein said composition is applied to said targeted plant, to soil in contact with said targeted plant, and/or to plant seeds of said targeted plant.

2. The use according to claim 1, characterized in that, said reducing the phytotoxicity of a herbicide and/or fungicide comprises lowering anthocyanin induction in the targeted plant.

3. The use according to claim 1, characterized in that, said reducing the phytotoxicity of a herbicide and/or fungicide comprises increasing harvest yield of said targeted plant.

4. The use according to claim 1, characterized in that, said reducing the phytotoxicity of a herbicide and/or fungicide comprises increasing plant seed germination and enhancing plant seedlings growth.

5. The use according to claim 1, characterized in that, said ferulated chitosan has a concentration of between 0.01 to 100.000 ppm based on the total weight of said composition.

6. The use according to claim 1, characterized in that, said composition comprises a water-insoluble solvent and water, wherein said composition is an oil-in-water emulsion having an oil to water ratio of between 1:20 to 20:20.

7. The use according to claim 6, characterized in that, said water-insoluble solvent has a concentration of between 5.00 and 50.00 wt. % based on the total weight of said composition.

8. The use according to claim 1, characterized in that, the composition comprises a rheological modifier, wherein said rheological modifier has a concentration of between 0.10 and 30.00 wt. % based on the total weight of said composition.

9. The use according to claim 1, characterized in that, the composition comprises a hydrophilic and/or a lipophilic surfactant, wherein said hydrophilic and/or lipophilic surfactant have a concentration of between 0.01 and 10.00 wt. % based on the total weight of said composition.

10. The use according to claim 6, characterized in that, the water-insoluble solvent is a vegetable oil or vegetable oil ester, chosen from linseed oil, rapeseed oil, soybean oil, palm oil, coconut oil, canola oil, sunflower oil, their esters, or combinations thereof.

11. The use according to claim 1, characterized in that, the composition has a pH of between 4.0 and 7.0.

12. The use according to claim 1, wherein the composition is applied to the targeted plant before, simultaneously with, or after application of a herbicide and/or fungicide.

13. The use according to claim 1, wherein the composition is applied to the targeted plant simultaneously with a herbicide and/or fungicide, the composition and the herbicide and/or fungicide are applied as a premix, said premix comprising the composition and the herbicide and/or fungicide in a ratio of between 1:10 and 1:20.000 based on the total weight of the premix.

14. The use according to claim 13, characterized in that, said herbicide and/or fungicide is chosen from (1) benzoic acid, (2) caroxylic acid, pyridines, (3) carboxylic acids (acetic acid, citric acid, pelargonic acid), (4) imidazolinone (imazapic, imazamox, imazamethabenz, imazapyr, imazaquin, imazethapyr), (5) sulfonylurea (chlorimuron, chlorsulfuron, foramsulfuron, halosulfuron, iodosulfuron, metsulfuron, nicosulfuron, primisulfuron, prosulfuron, rimsulfuron, sulfometuron, sulfosulfuron, thifensulfuron, trasulfuron, tribenuron, amidosulfuron, azimsulfuron, bensulfuron-methyl, flazasulfuron, flupyrsulfuron-methyl, mesosulfuron-methyl), (6) sulfonylamino-carboynyl-triazolinones (cloransulam, flumetsulam, florasulam), (7) amino acid derivative (glycines, glyphosates), (8) aryloxyphenoxy propionates (clodinafop-propargyl, diclofop-methyl, fluazifop-butyl, quizalofop-p-ethyl), (9) cyclohexanediones (clethodim, profoxidym, sethoxydim, tralkoxydim), (10) phenylpyrazoline (pinoxaben), (11) dinitroanilines, (12) carbamates and thiocarbamates (phenmedipham, prosulfocarb, triallate), (13) chloroacetamides and oxyacetamides (metazachlor, pethoxamide, flufenacet), (14) triazines, (15) triazinones (metamitron, metribuzin), (16) uracil (lenacil), (17) nitrile (bromoxynil), (18) triketone (mesotrione), (19) phosphonic acid (glufosinate-amonium), (20) diphenyl ether (aclonifen), (21) triazinone (trifludimoxazin), (22) benzofuran (ethofumesate), (23) benzothiadiazinone (bentazon), (24) phenoxy-carboxylic-acid (2.4-d, mcpa), (25) strobilurin (azoxystrobine, pyraclostrobin), (26) phenylpyrrole (fludioxynil), (27) phenylamide (metalaxyl, metalaxyl-m), (28) benzimidazole (thiabendazole, thiophanate-methyl), (29) triazole (difenoconazole, tebuconazole, myclobutanil, metconazole), (30) anilopyrimidine (cyprodinil), (31) cyanoacetamide-oxime (cymoxanil), (32) pyrazole (sedaxane), (33) carbamate (thiram), (34) pyrazolium (fluxapyroxad), (35) phenylpyridinamine (fluazinam), (36) phenylurea (pencycuron), (37) chloronitrile (chlorothanlonil), (38) oxathiin-carboxamide (carboxime), (39) dithiocarbamates (mancozeb), (40) dicarboximide (iprodione), (41) amide (benzovindiflupir), (42) carboxamide (pydiflumetofen), (43) mandelamide (mandipropamide), (44) benzamide (fluopyram), (45) pyrazole (fluxapyroxad), (46) carboxamide (boscalid), (47) morpholine (fenpropimorph), (48) inorganic compound (copper based products), or combinations thereof.

15. The use according to claim 13, said reducing the phytotoxicity of a herbicide and/or fungicide comprising improving the combatting of weed in a crop of the targeted plant.

16. A method for the production of ferulated chitosan comprising the steps of:
dispersing chitosan in a solution with a pH between 5.0 and 9.0 and adding ferulic acid and an enzyme of the family of multi-copper oxidases, obtaining a mixture;
allowing the mixture to enzymatically react;
recovering a precipitate from the reacted mixture.

17. Ferulated chitosan obtainable according to claim 17.

18. The use according to claim 1, characterized in that, said ferulated chitosan comprises an oligomeric and/or polymeric compound following formula 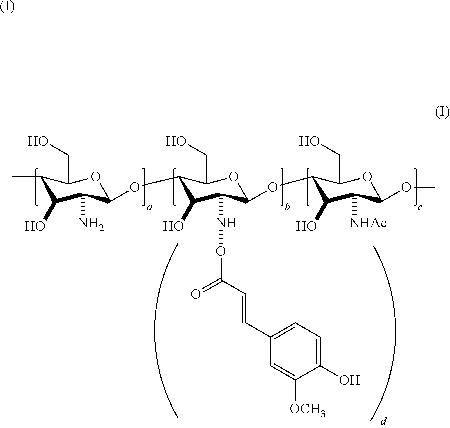
which compound comprises a D-glucosamine moiety (a), a ferulated D-glucosamine moiety (b), an acetylated D-glucosamine moiety (c), wherein said moieties are randomly distributed in said compound following a ratio a:b:c, wherein:
a+b+c>15;
b/(a+b+c)<0.10; and
c/(a+b+c)<0.30;
and wherein d=1, 2 or 3.

19. The use according to claim 11, characterized in that, the pH is between 5.0 and 6.5.
